(19) United States
(12) Patent Application Publication
(10) Pub. No.: US 2023/0201964 A1
(43) Pub. Date: Jun. 29, 2023

(54) ADDITIVE MANUFACTURING APPARATUS AND ADDITIVE MANUFACTURING METHOD

(71) Applicant: Mitsubishi Electric Corporation, Tokyo (JP)

(72) Inventors: Shun KAYASHIMA, Tokyo (JP); Nobuyuki SUMI, Tokyo (JP); Seiji UOZUMI, Tokyo (JP)

(73) Assignee: Mitsubishi Electric Corporation, Tokyo (JP)

(21) Appl. No.: 17/912,045

(22) PCT Filed: Nov. 17, 2020
(86) PCT No.: PCT/JP2020/042770

§ 371 Date: Sep. 16, 2022

(51) Int. Cl. B23K 26/342; B22F 10/22; B22F 10/368; B22F 10/85; B33Y 10/00; B33Y 30/00; B33Y 50/02

(52) U.S. Cl. CPC B23K 26/342; B22F 10/22; B22F 10/368; B22F 10/85; B33Y 10/00; B33Y 30/00; B33Y 50/02

(57) ABSTRACT

An additive manufacturing apparatus manufactures a shaped object by stacking a bead that is a solidified product of a filler metal caused to be melted. The additive manufacturing apparatus includes: a feeding unit that feeds the filler metal to a workpiece; a beam source that outputs a beam for melting the filler metal that is fed; and a position calculation unit that calculates a tip position of the filler metal, the tip position being a position where a temperature reaches a melting point of the filler metal by irradiation with the beam, on the basis of a feeding speed of the filler metal to be fed to the workpiece and beam power from the beam source.

### FIELD

The present disclosure relates to an additive manufacturing apparatus and an additive manufacturing method for manufacturing a three-dimensionally shaped object.

### BACKGROUND

As one of techniques for manufacturing a three-dimensionally shaped object, a technique of additive manufacturing (AM) is known. According to a directed energy deposition (DED) system, which is one of a plurality of systems in the technique of additive manufacturing, an additive manufacturing apparatus forms a bead by moving a machining point which is an irradiation position of a beam while feeding a filler metal to the machining point. The bead is a solidified product obtained by solidification of the filler metal that has melted. The additive manufacturing apparatus manufactures a shaped object by sequentially stacking beads.

Some DED additive manufacturing apparatuses form a bead by feeding a wire as a filler metal to a workpiece and locally melting a tip portion of the wire with a laser beam. In an additive manufacturing apparatus that melts a wire fed to a workpiece with a laser beam, there may be a case where the wire melts at a position away from the workpiece, and thereby a molten material remains on the wire. In that case, while no molten material is added to the workpiece, a drop which is a mass of the filler metal melted remains on the wire. Such a phenomenon is referred to as a drop phenomenon. In addition, in such an additive manufacturing apparatus that melts a wire fed to a workpiece with a laser beam, a stub phenomenon may occur in which the wire before melting collides with the workpiece.

In additive manufacturing apparatuses, the drop phenomenon or the stub phenomenon occurs when a positional relationship between a wire tip and a workpiece during machining is not appropriate. When the drop phenomenon or the stub phenomenon occurs, it is difficult for the additive manufacturing apparatuses to continue stable machining. In order to continue stable machining, the additive manufacturing apparatuses are required to be capable of maintaining an appropriate positional relationship between the workpiece and the wire tip during machining. In order to maintain the appropriate positional relationship between the workpiece and the wire tip, the additive manufacturing apparatuses are required to be capable of estimating the position of the wire tip during machining.

Patent Literature 1 discloses a method for calculating a distance between a tip which is a power feeding point and an object to be welded during welding in order to perform welding while maintaining a constant distance between the tip and the object to be welded in arc welding in which an arc is generated between the object to be welded and a wire. In the method disclosed in Patent Literature 1, a welding current flowing in a wire is detected, and a melting speed of the wire is obtained on the basis of wire extension and a value of the detected welding current. In the method disclosed in Patent Literature 1, a change in the wire extension is obtained on the basis of the melting speed of the wire and a feeding speed of the wire, and the distance between the tip and the object to be welded is calculated using a calculation result of the change in the wire extension.

### CITATION LIST

### Patent Literature

Patent Literature 1: Japanese Patent Application Laid-open No. 2000-158136

### SUMMARY

### Technical Problem

The method according to Patent Literature 1 is a method applied to a case of arc welding, and requires inputs of a detection result of the welding current flowing through the wire, electric conductivity of the wire, and the like, for calculation for obtaining the distance between the tip and the object to be welded. In a case of an additive manufacturing apparatus that melts a wire with a laser beam, a position of a wire tip during machining cannot be obtained by the method according to Patent Literature 1. Therefore, according to the technique of Patent Literature 1, there is a problem in that, in machining in which a filler metal fed to a workpiece is melted by irradiation with a beam, a position of a tip of the filler metal during machining cannot be estimated.

The present disclosure has been made in view of the above, and an object thereof is to provide an additive manufacturing apparatus that, in machining in which a filler metal fed to a workpiece is melted by irradiation with a beam, can estimate a position of a tip of the filler metal during machining.

### Solution to Problem

To solve the above problems and achieve an object, an additive manufacturing apparatus according to the present disclosure manufactures a shaped object by stacking a bead that is a solidified product of a filler metal caused to be melted. The additive manufacturing apparatus includes: a feeding unit to feed the filler metal to a workpiece; a beam source to output a beam for melting the filler metal that is fed; and a position calculation unit to calculate a tip position of the filler metal, the tip position being a position where a temperature reaches a melting point of the filler metal by irradiation with the beam, on a basis of a feeding speed of the filler metal to be fed to the workpiece and beam power from the beam source.

### Advantageous Effects of Invention

The additive manufacturing apparatus according to the present disclosure achieves an effect that, in machining in which a filler metal fed to a workpiece is melted by irradiation with a beam, it is possible to estimate a position of a tip of the filler metal during machining.

### BRIEF DESCRIPTION OF DRAWINGS

FIG. 1 is a diagram illustrating a configuration of an additive manufacturing apparatus according to a first embodiment.

FIG. 2 is a diagram illustrating a functional configuration of a numerical control device that controls the additive manufacturing apparatus according to the first embodiment.

FIG. 3 is a view for explaining how a shaped object is formed by the additive manufacturing apparatus according to the first embodiment.

FIG. 4 is a view for explaining a method for estimating a tip position of a wire as a filler metal by the additive manufacturing apparatus according to the first embodiment.

FIG. 5 is a view for explaining a relationship between a status of machining by the additive manufacturing apparatus according to the first embodiment and the tip position of the wire.

FIG. 6 is a view for explaining a method for correcting a machining reference point by the additive manufacturing apparatus according to the first embodiment.

FIG. 7 is a flowchart illustrating an operation procedure in manufacture of a shaped object by the additive manufacturing apparatus according to the first embodiment.

FIG. 8 is a view for explaining a preliminary experiment for obtaining a relationship between boundary values of a feeding speed and laser power in the additive manufacturing apparatus according to a second embodiment.

FIG. 9 is a diagram illustrating an example of the relationship between boundary values of the feeding speed and the laser power obtained in the additive manufacturing apparatus according to the second embodiment.

FIG. 10 is a diagram illustrating a functional configuration of a numerical control device that controls the additive manufacturing apparatus according to a third embodiment.

FIG. 11 is a view for explaining an example in which a process parameter is changed in the additive manufacturing apparatus according to a fourth embodiment.

FIG. 12 is a view for explaining a method for calculating the tip position in the additive manufacturing apparatus according to the fourth embodiment.

FIG. 13 is a first view for explaining estimation of the tip position including adjustment with respect to a transient response by the additive manufacturing apparatus according to the fourth embodiment.

FIG. 14 is a second view for explaining the estimation of the tip position including the adjustment with respect to the transient response by the additive manufacturing apparatus according to the fourth embodiment.

FIG. 15 is a view for explaining correction of a position of the machining reference point in a Z-axis direction and a moving direction of the machining reference point in the additive manufacturing apparatus according to a fifth embodiment.

FIG. 16 is a diagram for explaining the definition of an angle representing the moving direction of the machining reference point in the additive manufacturing apparatus according to the fifth embodiment.

FIG. 17 is a view for explaining adjustment of a correction amount for correcting a position of the machining reference point by the additive manufacturing apparatus according to the fifth embodiment.

FIG. 18 is a view for explaining a method for estimating the height of a bead by the additive manufacturing apparatus according to the fifth embodiment.

FIG. 19 is a diagram illustrating an example hardware configuration of each numerical control device included in the additive manufacturing apparatus according to the first to fifth embodiments.

### DESCRIPTION OF EMBODIMENTS

Hereinafter, an additive manufacturing apparatus and an additive manufacturing method according to each embodiment will be described in detail with reference to the drawings.

### First Embodiment

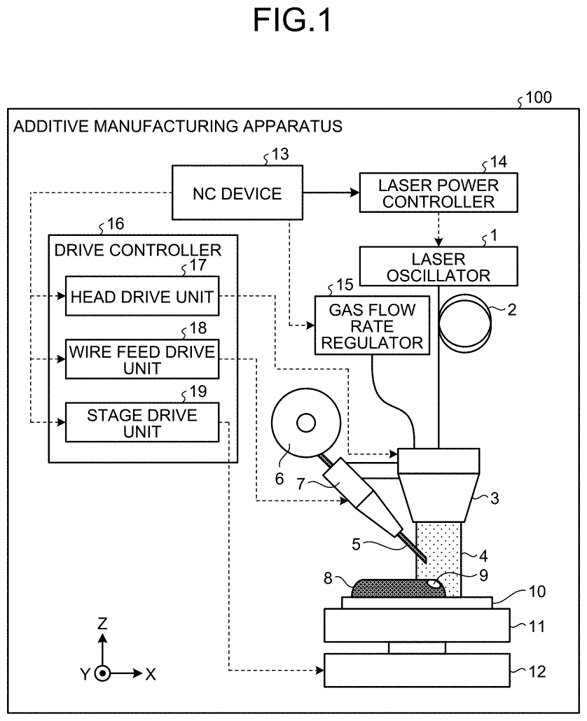

FIG. 1 is a diagram illustrating a configuration of an additive manufacturing apparatus 100 according to a first embodiment. The additive manufacturing apparatus 100 is a machining apparatus that manufactures a three-dimensionally shaped object by adding a molten filler metal to a workpiece. The additive manufacturing apparatus 100 melts the filler metal by irradiation with a beam. In the first embodiment, the beam is a laser beam 4, and the filler metal is a wire 5 made of metal.

The additive manufacturing apparatus 100 locally melts a tip portion of the wire 5 fed to a workpiece with the laser beam 4 and brings a molten material of the wire 5 into contact with the workpiece to thereby form a bead 8. The bead 8 is a solidified product of the filler metal melted by irradiation with the beam. The additive manufacturing apparatus 100 manufactures a shaped object by stacking the beads 8 on a substrate 10. The substrate 10 illustrated in FIG. 1 is a plate material. The substrate 10 may be a material other than the plate material. The workpiece is an object to which the molten filler metal is added, and is the substrate 10 or the bead 8 on the substrate 10. A molten bead 9 is a portion of the bead 8 that is melted.

An X axis, a Y axis, and a Z axis are three axes perpendicular to one another. The X axis and the Y axis are axes in the horizontal direction. The Z axis is an axis in the vertical direction. In each of an X-axis direction, a Y-axis direction, and a Z-axis direction, a direction indicated by an arrow may be referred to as a positive direction, and a direction opposite to the arrow may be referred to as a negative direction. The Z-axis direction is a stacking direction that is a direction in which the beads 8 are stacked.

A laser oscillator 1 which is a beam source outputs the laser beam 4. The laser beam 4 output by the laser oscillator 1 propagates to a machining head 3 through a fiber cable 2 which is an optical transmission line. A laser power controller 14 controls the laser oscillator 1 to thereby adjust beam power of the laser oscillator 1. In the following description, the beam power is also referred to as laser power.

The machining head 3 moves in each of the X-axis direction, the Y-axis direction, and the Z-axis direction. The machining head 3 emits the laser beam 4 toward the workpiece. A collimating optical system that collimates the laser beam 4 and a condenser lens that focuses the laser beam 4 are provided inside the machining head 3. The collimating optical system and the condenser lens are not illustrated. A direction of the centerline of the laser beam 4 with which the workpiece is irradiated is the Z-axis direction.

The machining head 3 includes a gas nozzle that injects shielding gas toward the workpiece. As the shielding gas, argon gas which is an inert gas is used. By injection of the shielding gas, the additive manufacturing apparatus 100 prevents oxidation of the bead 8 and cools the bead 8 that has been formed. The shielding gas is supplied from a gas cylinder which is a supply source of the shielding gas. A gas flow rate regulator 15 adjusts the flow rate of the shielding gas. The gas nozzle and the gas cylinder are not illustrated.

A wire spool 6 which is a supply source of the wire 5 is attached to the additive manufacturing apparatus 100. The wire 5 is wound around the wire spool 6. A feeding unit 7 is fixed to the machining head 3. The feeding unit 7 feeds the filler metal to the workpiece. The feeding unit 7 feeds the wire 5 from the wire spool 6 toward the workpiece. In addition, the feeding unit 7 pulls back the fed wire 5 toward the wire spool 6. The direction in which the wire 5 is fed is a direction oblique to a direction in which the laser beam 4 is emitted from the machining head 3.

The substrate 10 is fixed to a rotary stage 11. The rotary stage 11 rotates about the Z axis. A rotary stage 12 changes the inclination of the rotary stage 11 by rotation about the Y axis. The additive manufacturing apparatus 100 changes the posture of the substrate 10 by the operations of the rotary stages 11 and 12. The additive manufacturing apparatus 100 moves an irradiation position of the laser beam 4 on the workpiece by changing the posture of the substrate 10 and moving the machining head 3.

A drive controller 16 includes a head drive unit 17 that drives the machining head 3, a wire feed drive unit 18 that drives the feeding unit 7, and a stage drive unit 19 that drives the rotary stages 11 and 12.

The additive manufacturing apparatus 100 includes a numerical control (NC) device 13 that controls the additive manufacturing apparatus 100. The NC device 13 controls the entirety of the additive manufacturing apparatus 100 in accordance with a machining program. The NC device 13 controls the laser oscillator 1 by outputting a laser power command to the laser power controller 14. The NC device 13 controls the machining head 3 by outputting an axis command to the head drive unit 17. The NC device 13 controls the feeding unit 7 by transmitting a feed command to the wire feed drive unit 18. The NC device 13 controls the rotary stages 11 and 12 by outputting a rotation command to the stage drive unit 19. The NC device 13 controls the flow rate of the shielding gas by outputting a gas supply command to the gas flow rate regulator 15.

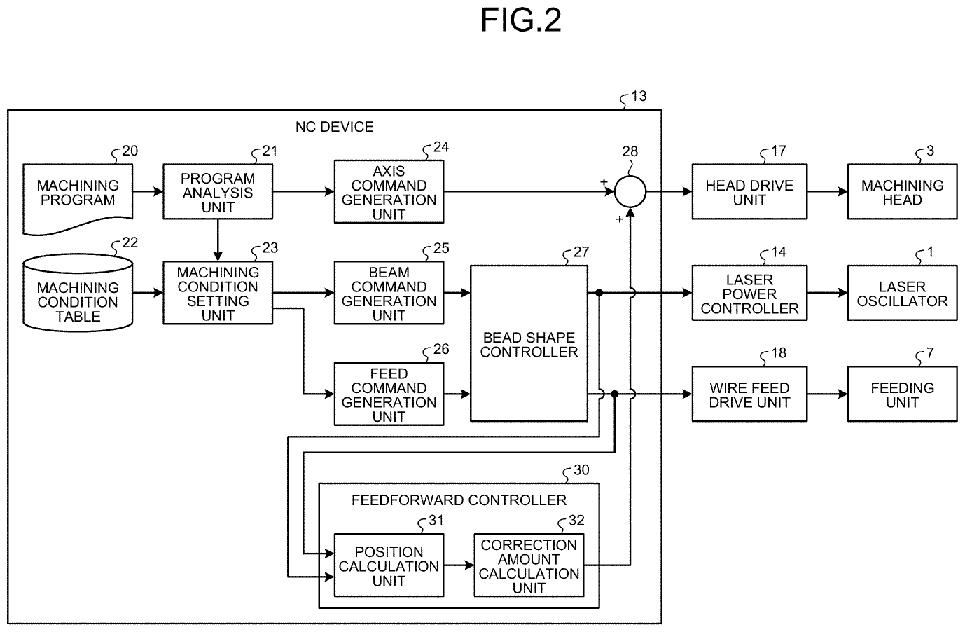

FIG. 2 is a diagram illustrating a functional configuration of the numerical control device that controls the additive manufacturing apparatus 100 according to the first embodiment. A machining program 20 which is an NC program is input to the NC device 13. The machining program 20 is created by a computer-aided manufacturing (CAM) apparatus.

The NC device 13 includes a program analysis unit 21 that analyzes the machining program 20, a machining condition setting unit 23 that sets a machining condition, an axis command generation unit 24 that generates an axis command, a beam command generation unit 25 that generates a laser power command, and a feed command generation unit 26 that generates a feed command.

The program analysis unit 21 analyzes a travel path along which the machining head 3 is moved on the basis of a description of the machining program 20. The program analysis unit 21 outputs an analysis result of the travel path to the axis command generation unit 24. In addition, the program analysis unit 21 acquires information for setting machining conditions from the machining program 20. The program analysis unit 21 outputs the information for setting machining conditions to the machining condition setting unit 23.

The NC device 13 includes a machining condition table 22 in which data of various machining conditions are stored. The machining condition setting unit 23 sets a machining condition by reading data of the machining condition from the machining condition table 22 in accordance with the information for setting machining conditions. Note that instead of obtaining the data of the designated machining condition from the data of various machining conditions stored in advance in the machining condition table 22, the NC device 13 may obtain the data of the machining condition from the machining program 20 in which the data of the machining condition is described.

The axis command generation unit 24 generates an axis command which is a group of interpolation points for each unit time on the travel path, on the basis of the analysis result of the travel path. In the following description, the interpolation point is also referred to as a command point. The beam command generation unit 25 generates a laser power command on the basis of the machining condition set by the machining condition setting unit 23. The feed command generation unit 26 generates a feed command on the basis of the machining condition set by the machining condition setting unit 23.

The NC device 13 includes a bead shape controller 27 that performs adjustment for improving shape accuracy of the bead 8, a feedforward controller 30, and an adder 28. The additive manufacturing apparatus 100 includes various sensors such as a camera, a thermometer, and a profilometer. The various sensors are not illustrated. Results of detections by the various sensors are input to the bead shape controller 27. The bead shape controller 27 adjusts process parameters such as a command value of a feeding speed and a command value of the laser power on the basis of the results of detections by the various sensors.

The additive manufacturing apparatus 100 adjusts the height and width of the bead 8 to be formed by adjustment of process parameters performed by the bead shape controller 27. The height of the bead 8 is the height of the bead 8 in the stacking direction. The width of the bead 8 is the width of the bead 8 in a direction perpendicular to the direction in which the machining head 3 is moved and the stacking direction. When the direction in which the machining head 3 is moved is the X-axis direction, the width of the bead 8 in the Y-axis direction is adjusted.

Examples of the camera include a visible light camera, an infrared camera, and a high-speed measurement camera. The camera measures the shape of the workpiece, the molten state of the workpiece, a shape of a molten pool, a temperature, and the like. With the camera included therein, the additive manufacturing apparatus 100 can observe the shape of the workpiece, the molten state of the workpiece, a molten state of the wire 5, fumes or spatters generated during machining, a position of the wire 5, a temperature of the workpiece, a temperature of the wire 5, a temperature of the molten pool, and the like. The thermometer detects light emitted from the workpiece. The thermometer is a non-contact type thermometer such as a radiation thermometer or a thermocamera. The profilometer is a measuring instrument that measures a shape of a shaped object, and is a laser displacement meter, an optical coherence tomography (OCT) device that performs optical coherence tomography, or the like. The profilometer measures the height of the shaped object in the Z-axis direction, the length of the shaped object in the X-axis direction, or the width of the shaped object in the Y-axis direction. Note that a spectroscope, a phonometer, and the like may be include in the various sensors.

The bead shape controller 27 outputs the adjusted laser power command to the laser power controller 14 and the feedforward controller 30. The bead shape controller 27 outputs the adjusted feed command to the wire feed drive unit 18 and the feedforward controller 30.

The feedforward controller 30 includes a position calculation unit 31 that calculates the tip position of the wire 5 and a correction amount calculation unit 32 that calculates a correction amount for correcting the position of the machining head 3. The position calculation unit 31 calculates the tip position of the wire 5 on the basis of the feeding speed of the wire 5 and the laser power by the laser oscillator 1. In the first embodiment, the position calculation unit 31 calculates the tip position of the wire 5 on the basis of the adjusted laser power command in the bead shape controller 27 and the adjusted feed command in the bead shape controller 27. The position calculation unit 31 outputs a calculation result of the tip position to the correction amount calculation unit 32.

A measurement value of the amount of displacement from an upper surface of the workpiece to the command point is input to the correction amount calculation unit 32. The amount of displacement is measured by a sensor such as a laser displacement meter. The correction amount calculation unit 32 calculates a correction amount in the stacking direction on the basis of the calculation result of the tip position and the amount of displacement. The correction amount calculation unit 32 outputs a calculation result of the correction amount to the adder 28. The adder 28 adds the correction amount to the axis command generated by the axis command generation unit 24. The correction amount calculation unit 32 and the adder 28 function as a correction unit that corrects the position of the machining reference point in the stacking direction on the basis of the calculation result of the tip position. The machining reference point will be described later. The adder 28 outputs a result of the addition, that is, the corrected axis command to the head drive unit 17.

Note that each of the above-described components of the NC device 13 may be functionally or physically distributed in any unit. For example, the bead shape controller 27 may be included in an external device which is a device connected to the NC device 13.

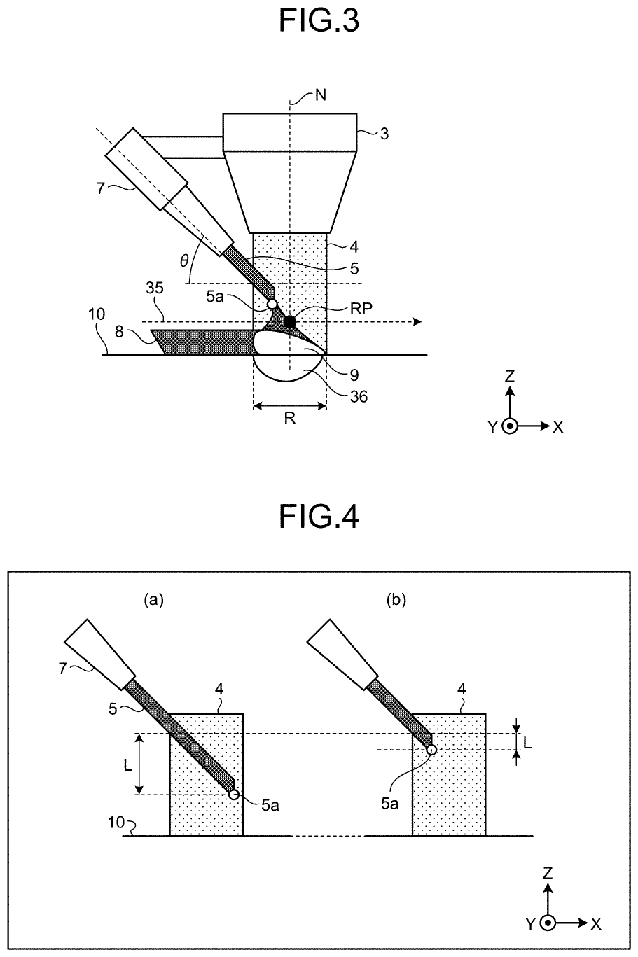

FIG. 3 is a view for explaining how a shaped object is formed by the additive manufacturing apparatus 100 according to the first embodiment. FIG. 3 schematically illustrates how the bead 8 is formed on the substrate 10.

“θ” is an angle formed by the traveling direction of the wire 5 directed toward the workpiece from the feeding unit 7, and the X axis which is an axis perpendicular to a centerline N of the laser beam 4. “θ” is a parameter indicating a direction of the filler metal to be fed to the workpiece, and is one of mechanical parameters related to the structure of the additive manufacturing apparatus 100. “R” is the diameter of a spot of the laser beam 4 in a plane perpendicular to the centerline N. A tip position 5a of the wire 5 is a position in the wire 5 where a temperature has reached the melting point of the wire 5 by irradiation with the laser beam 4.

An intersection of the centerline N of the laser beam 4 directed toward the workpiece and the traveling direction of the wire 5 directed toward the workpiece from the feeding unit 7, is defined as a reference point of the machining head 3. In the following description, the reference point of the machining head 3 is referred to as a machining reference point RP. The additive manufacturing apparatus 100 drives the machining head 3 so that the machining reference point RP coincides with a position 35 of the command point based on the machining program 20. A molten pool 36 is formed in a region of an upper surface of the substrate 10 on which a molten material of the wire 5 is placed. The molten bead 9 is formed on the molten pool 36.

Next, estimation of the tip position 5a of the wire 5 by the additive manufacturing apparatus 100 will be described. FIG. 4 is a view for explaining a method for estimating the tip position 5a of the wire 5 as a filler metal by the additive manufacturing apparatus 100 according to the first embodiment.

In order for the additive manufacturing apparatus 100 to continue stable machining without causing the drop phenomenon or the stub phenomenon, it is required to maintain an appropriate positional relationship between the workpiece and the tip position 5a. The additive manufacturing apparatus 100 can maintain the appropriate positional relationship between the workpiece and the tip position 5a by estimating the tip position 5a and correcting the position of the machining reference point RP on the basis of a result of the estimation. The additive manufacturing apparatus 100 estimates the tip position 5a by calculating the tip position 5a in the position calculation unit 31.

“L” is a distance between a position where the wire 5 entered the laser beam 4 at the start of machining and the tip position 5a where the temperature has reached the melting point after the entrance of the wire 5 into the laser beam 4. “L” is a distance in the Z-axis direction. FIG. 4 illustrates distances “L” in two cases in which the feeding speeds or the laser power levels are different to each other. In a case of (b) of FIG. 4, the feeding speed is lower or the laser power level is higher than that in a case of (a) of FIG. 4. The distance “L” in the case of (b) of FIG. 4 is shorter than the distance “L” in the case of (a) of FIG. 4. The position calculation unit 31 performs calculation of the tip position 5a from a process parameter on the basis of a relationship between the tip position 5a and the process parameter. Note that the calculation of the tip position 5a refers to calculation of the distance “L”.

Here, it is assumed that concerning heat input to the wire 5, heat other than absorption heat by the laser beam 4 is sufficiently smaller than the absorption heat. That is, heat conduction from the workpiece to the wire 5 is neglected, and the temperature of the wire 5 inside the laser beam 4 is assumed to be determined only by irradiation with the laser beam 4.

A temperature “T” of the wire 5 after a period “t” has elapsed since the wire 5 entered the laser beam 4 at the start of machining is expressed by the following formula (1).

T−T₀=(1/C_{P})·A·P_{C}·t (1)

“T₀” is an initial temperature of the wire 5. The initial temperature is a temperature of the wire 5 before being irradiated with the laser beam 4. The initial temperature nearly equals to room temperature. The unit of “T₀” is [K]. “C_{P}” is the heat capacity of the wire 5. The unit of “C_{P}” is [J/K]. “A” is the absorption rate of the wire 5. “P_{C}” is a command value of the laser power. The unit of “P_{C}” is [W].

A period “tₘₑₗₜ” from when the wire 5 enters the laser beam 4 up to when the tip portion of the wire 5 reaches a melting point “Tₘₑₗₜ” of the wire 5 is expressed by the following formula (2). Formula (2) is obtained by modifying formula (1) and substituting “Tₘₑₗₜ” and “tₘₑₗₜ” thereinto. Because “T₀” is sufficiently low with respective to “Tₘₑₗₜ”, “T₀” is neglected in formula (2).

tₘₑₗₜ=(1/A·P_{C})·C_{P}·Tₘₑₗₜ (2)

Because the angle formed by the traveling direction of the wire 5 and the X axis is “θ”, the distance “L” is expressed by the following formulas (3) and (4) with “K” as a constant.

L=tₘₑₗₜ·F_{WC}·sin θ (3)

L=K·(F_{WC}/P_{C}) (4)

“F_{WC}” is a command value of the feeding speed of the wire 5. “K” is a constant obtained by reflecting physical property values of the wire 5 such as the heat capacity “C_{P}”, the absorption rate “A”, and the melting point “Tₘₑₗₜ”, and “sine” which is a mechanical parameter of the additive manufacturing apparatus 100. “F_{WC}” and “P_{C}” are process parameters of the additive manufacturing apparatus 100.

According to the above description, it can be seen that the tip position 5a of the wire 5 changes not only by the position 35 of the command point based on the machining program 20 but also by the process parameters. Note that in the first embodiment, the constant “K” can be determined according to any method. As a physical property value for determining the constant “K”, a numerical value described in literatures or the like can be used. The constant “K” may be determined by a preliminary experiment. The determination of the constant “K” by the preliminary experiment will be described in a second embodiment.

In the first embodiment, the additive manufacturing apparatus 100 estimates the tip position 5a on the basis of the period “tₘₑₗₜ” in a case where there has been no change in the process parameters since the wire 5 entered the laser beam 4, that is, in a steady state. The estimation of the tip position 5a including the adjustment with respect to the transient response due to a temporal change in a process parameter will be described in a fourth embodiment.

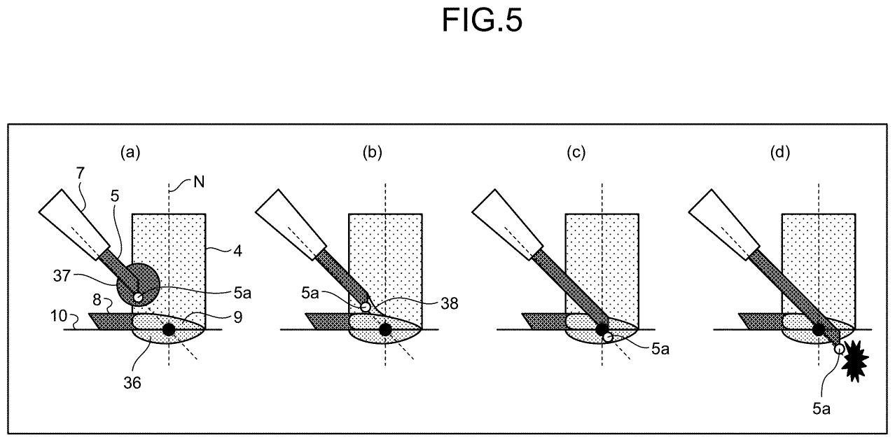

Next, a relationship between a status of machining by the additive manufacturing apparatus 100 and the tip position 5a of the wire 5 will be described. FIG. 5 is a view for explaining the relationship between the status of machining by the additive manufacturing apparatus 100 according to the first embodiment and the tip position 5a of the wire 5. FIG. 5 schematically illustrates the status of machining in four cases in which the feeding speeds or the laser power levels are different thereamong. The tip positions 5a in the Z-axis direction in the four cases are different from one another. A case of (a) of FIG. 5 is a case where the tip position 5a is present vertically uppermost among the four cases. In FIG. 5, the tip position 5a of (a) is present vertically uppermost, and followed by the tip positions 5a of (b), (c), and (d), in this order.

In the case of (a) of FIG. 5, the tip position 5a is separated from the molten bead 9 vertically thereabove. In such a case, a drop 37 is formed at the tip portion of the wire 5 due to melting of the wire 5 at a position away from the molten bead 9. That is, the drop phenomenon occurs.

In a case of (b) of FIG. 5, the tip position 5a is present vertically above an upper surface of the molten bead 9. In addition, a link 38 caused by surface tension of the molten material is formed between the tip position 5a and the molten bead 9. In such a case, because the tip position 5a is connected to the molten bead 9 via the link 38, machining can be continued. However, because the link 38 is easily disconnected due to disturbance or the like, it can be said that the status in the case of (b) is a status that easily transitions into the status in the case of (a), and easily causes the drop phenomenon to occur.

In a case of (c) of FIG. 5, the tip position 5a is present vertically below the upper surface of the molten bead 9, and vertically above a bottom surface of the molten pool 36. In such a case, the contact between the molten material of the wire 5 and the molten bead 9 is maintained, and thereby the drop phenomenon does not occur. In addition, a distance between the bottom surface of the molten pool 36 and the tip position 5a is maintained, and thereby the stub phenomenon does not occur. In the case of (c), neither the drop phenomenon nor the stub phenomenon occurs, and the additive manufacturing apparatus 100 can continue stable machining.

In a case of (d) of FIG. 5, the tip position 5a is present vertically below the bottom surface of the molten pool 36. Alternatively, the wire 5 is fed so that the tip position 5a further advances vertically downward from a state where the wire 5 has reached the bottom surface of the molten pool 36, and thereby the tip of the wire 5 is pressed against the bottom surface of the molten pool 36. In the case of (d), the stub phenomenon occurs.

As described above, the additive manufacturing apparatus 100 can continue stable machining in a state where the tip position 5a is present between the upper surface of the molten bead 9 and the bottom surface of the molten pool 36. It is difficult for the additive manufacturing apparatus 100 to continue stable machining in a state where the tip position 5a is separated from the molten bead 9 vertically thereabove or in a state where the wire 5 is fed so that the tip position 5a is present vertically below the bottom surface of the molten pool 36.

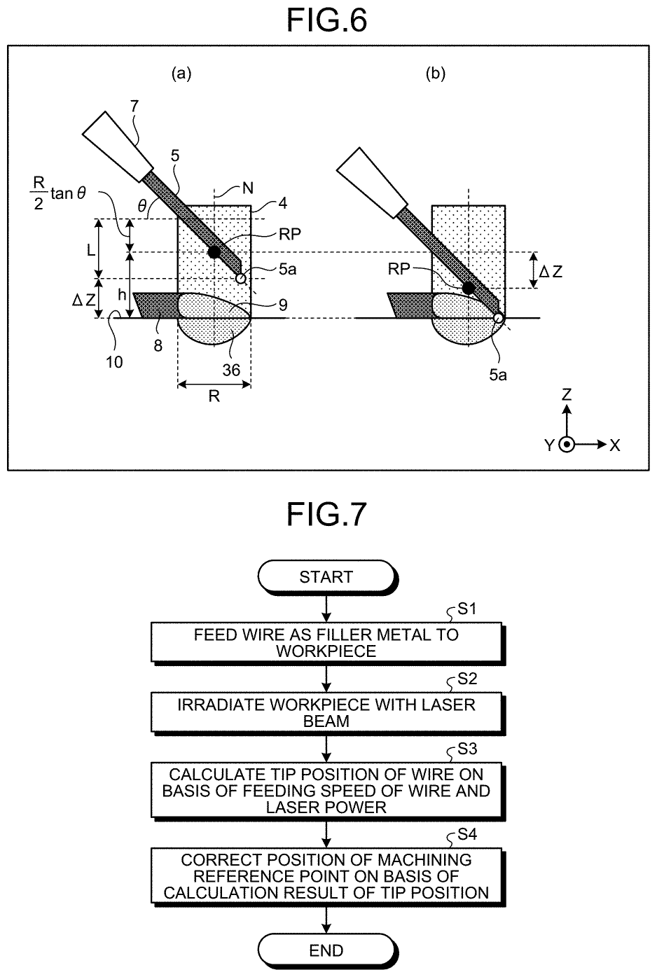

Next, the correction of the position of the machining reference point RP by the additive manufacturing apparatus 100 will be described. FIG. 6 is a view for explaining a method for correcting the machining reference point RP by the additive manufacturing apparatus 100 according to the first embodiment. (a) of FIG. 6 schematically illustrates a state of the tip position 5a and the workpiece before the position of the machining reference point RP is corrected. (b) of FIG. 6 schematically illustrates a state of the tip position 5a and the workpiece after the position of the machining reference point RP is corrected. By correcting the position of the machining reference point RP, the state of the tip position 5a and the workpiece transition from the state illustrated in (a) of FIG. 6 to the state illustrated in (b) of FIG. 6.

In the state illustrated in (a) of FIG. 6, the tip position 5a is separated from the molten bead 9 vertically thereabove. A laser power command value after adjustment by the bead shape controller 27 and a feeding speed command value after adjustment by the bead shape controller 27 are input to the position calculation unit 31. The position calculation unit 31 calculates the distance “L” on the basis of the above-described formula (4). The position calculation unit 31 outputs a calculation result of the distance “L” to the correction amount calculation unit 32.

The amount of displacement “h” from the upper surface of the substrate 10 which is the workpiece to the machining reference point RP, is measured by a sensor such as a laser displacement meter. A measurement value of the amount of displacement “h” is input to the correction amount calculation unit 32.

The correction amount calculation unit 32 calculates a distance between the upper surface of the substrate 10 and the tip position 5a in the Z-axis direction, as the correction amount. “ΔZ” which is the correction amount is expressed by the following formula (5).

ΔZ=−h−(R/2)tan θ+L (5)

The correction amount calculation unit 32 calculates “ΔZ” on the basis of formula (5). The correction amount calculation unit 32 outputs a calculation result of “ΔZ” to the adder 28. The adder 28 adds “ΔZ” to the axis command generated by the axis command generation unit 24. The machining head 3 is controlled in accordance with the corrected axis command, and thereby the position of the machining reference point RP is lowered by “ΔZ” from the position thereof in the state illustrated in (a) of FIG. 6. Due to the lowered position of the machining reference point RP, the tip position 5a comes into contact with the molten bead 9 as illustrated in (b) of FIG. 6.

As described above, the additive manufacturing apparatus 100 corrects the position of the machining reference point RP in the stacking direction on the basis of the calculation result of the tip position 5a. Even when any of the process parameters changes during machining, the additive manufacturing apparatus 100 can bring the tip position 5a into contact with the molten bead 9 by correcting the position of the machining reference point RP. By constantly bringing the tip position 5a into contact with the molten bead 9, the additive manufacturing apparatus 100 can maintain a state that enables stable machining.

Next, a procedure of an additive manufacturing method in which the additive manufacturing apparatus 100 according to the first embodiment manufactures a shaped object will be described. FIG. 7 is a flowchart illustrating an operation procedure in manufacture of a shaped object by the additive manufacturing apparatus 100 according to the first embodiment.

In step S1 which is a feeding step, the additive manufacturing apparatus 100 feeds the wire 5 as a filler metal to the workpiece. In step S2 which is a beam output step, the additive manufacturing apparatus 100 outputs the laser beam 4 from the laser oscillator 1 to thereby irradiate the workpiece with the laser beam 4. The additive manufacturing apparatus 100 melts the thus fed wire 5 with the laser beam 4 to form the bead 8.

In step S3 which is a position calculation step, the additive manufacturing apparatus 100 calculates the tip position 5a of the wire 5 on the basis of the feeding speed of the wire 5 in step S1 and the laser power in step S2. The additive manufacturing apparatus 100 estimates the tip position 5a during machining by step S3. In step S4 which is a correction step, the additive manufacturing apparatus 100 corrects the position of the machining reference point RP on the basis of the calculation result of the tip position 5a in step S3. The additive manufacturing apparatus 100 repeats the operation of forming the beads 8 while correcting the position of the machining reference point RP. The additive manufacturing apparatus 100 manufactures a shaped object by stacking the beads 8 on the substrate 10.

According to the first embodiment, the additive manufacturing apparatus 100 calculates the tip position 5a of the wire 5 on the basis of the feeding speed of the wire 5 that is a filler metal to be fed to the workpiece, and the beam power by the beam source. Consequently, the additive manufacturing apparatus 100 achieves an effect in that, in machining in which a filler metal fed to a workpiece is melted by irradiation with a beam, it is possible to estimate a position of a tip of the filler metal during machining. In addition, by correcting the position of the machining reference point RP in the stacking direction on the basis of the calculation result of the tip position 5a, the additive manufacturing apparatus 100 can maintain a state where stable machining can be performed.

### Second Embodiment

In the first embodiment, the constant “K” can be determined according to any method. In the second embodiment, a description will be given for a method for determining the constant “K” on the basis of the preliminary experiment. The additive manufacturing apparatus 100 can accurately estimate the tip position 5a by determining the constant “K” on the basis of a result of the preliminary experiment, which uses a filler metal and the additive manufacturing apparatus 100 that are actually used in machining. In the second embodiment, the same components as those in the first embodiment are denoted by the same reference numerals, and configurations different from those in the first embodiment will mainly be described.

In the second embodiment, the additive manufacturing apparatus 100 obtains a relationship between boundary values of a feeding speed and laser power by the laser oscillator 1 by the preliminary experiment. A boundary value of the feeding speed is a minimum value of the feeding speed in a case where the wire 5 fed toward the laser beam 4 passes through the laser beam 4 without being melted. The position calculation unit 31 calculates the constant “K” on the basis of the relationship between boundary values of the feeding speed and the laser power.

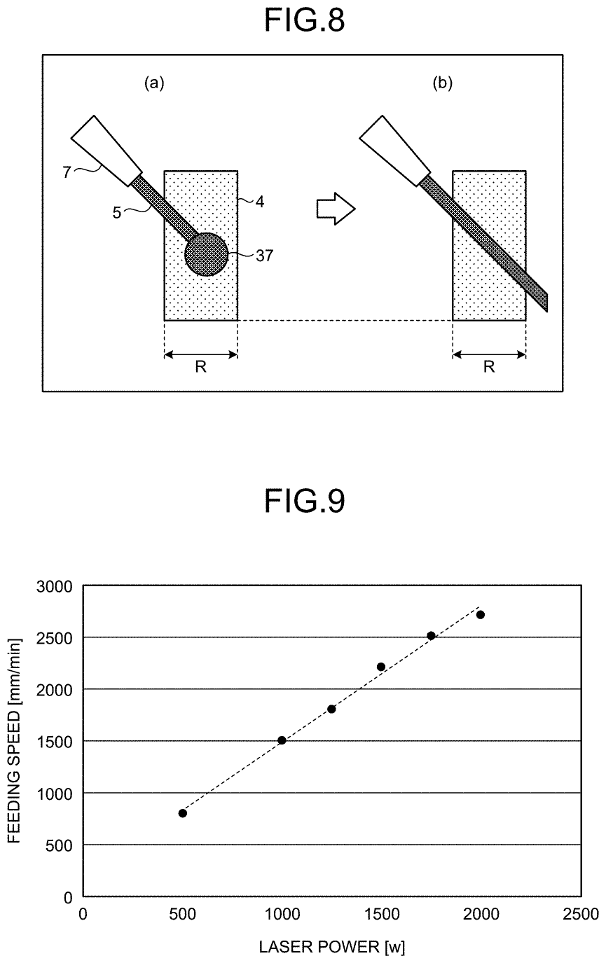

Here, the preliminary experiment will be described. FIG. 8 is a view for explaining the preliminary experiment for obtaining the relationship between boundary values of the feeding speed and the laser power in the additive manufacturing apparatus 100 according to the second embodiment.

In the preliminary experiment, the machining head 3 is caused to remain still at a position vertically above the position thereof at the time of machining. The additive manufacturing apparatus 100 irradiates the laser beam 4 at arbitrary laser power while keeping the machining head 3 stationary, and feeds the wire 5 toward the laser beam 4. FIG. 8 illustrates a state where the wire 5 is fed in two cases in which the feeding speeds are different to each other while setting a command value of the laser power to a certain value. In a case of (b) of FIG. 8, the feeding speed is higher than that in a case of (a) of FIG. 8.

In the case of (a) of FIG. 8, the tip portion of the wire 5 melts after the wire 5 enters the laser beam 4 and before the wire 5 passes through the laser beam 4. The drop 37 is formed at the tip portion of the wire 5. The additive manufacturing apparatus 100 sequentially increases the feeding speed from that in the case of (a) of FIG. 8 and feeds the wire 5, repeatedly. When the feeding speed of the wire 5 becomes higher than a certain value, the wire 5 passes through the laser beam 4. The feeding speed at which the wire 5 starts passing through the laser beam 4 is a boundary value. In this manner, the additive manufacturing apparatus 100 obtains boundary values corresponding to command values of the laser power. Detection results obtained by various sensors can be used to determine whether the wire 5 has passed through the laser beam 4.

The additive manufacturing apparatus 100 repeats the above operation for acquiring a boundary value a plurality of times while changing a command value of the laser power. Consequently, the additive manufacturing apparatus 100 obtains a plurality of sets of (P_{C}n, F_{WC}n), which are sets each including a command value P_{C}n of the laser power and a boundary value F_{WC}n. “n” represents the number of times of sampling which is the above operation for acquiring a boundary value, and is any integer of 2 or more. The additive manufacturing apparatus 100 stores a plurality of sets of (P_{C}n, F_{WC}n).

FIG. 9 is a diagram illustrating an example of the relationship between boundary values of the feeding speed and the laser power obtained in the additive manufacturing apparatus 100 according to the second embodiment. In the graph illustrated in FIG. 9, the vertical axis represents the feeding speed of the wire 5, and the horizontal axis represents the laser power. Each point illustrated in FIG. 9 is obtained by plotting each of the plurality of sets of (P_{C}n, F_{WC}n). A dashed straight line illustrated in FIG. 9 represents an approximate expression of the plurality of sets of (P_{C}n, F_{WC}n). FIG. 9 illustrates six points representing results of six times of sampling and an approximate expression obtained from the results.

Each of the plurality of sets of (P_{C}n, F_{WC}n) satisfies the following formulas (6) and (7). The additive manufacturing apparatus 100 calculates the constant “K” using a least squares method on the basis of the plurality of sets of (P_{C}n, F_{WC}n) and the relationship of the formula (7).

R tan θ=K·F_{WC}n/P_{C}n (6)

K=R tan θ·P_{C}n/F_{WC}n (7)

The additive manufacturing apparatus 100 calculates the tip position 5a of the wire 5 by calculation using the calculated constant “K”. The constant “K” is calculated before machining that uses the wire 5 made of a material that is different from the material for the wire 5 used in the past in the additive manufacturing apparatus 100. The constant “K” may be calculated at the time of manufacturing the additive manufacturing apparatus 100.

According to the method of the second embodiment, the constant “K” that reflects the physical property values of the wire 5 and the mechanical parameter can be calculated for the wire 5 and the additive manufacturing apparatus 100 that are actually used. The additive manufacturing apparatus 100 can reduce errors in the constant “K” with respect to the physical property values of the wire 5 actually used and the mechanical parameter of the additive manufacturing apparatus 100 actually used. Consequently, the additive manufacturing apparatus 100 can accurately estimate the tip position 5a.

### Third Embodiment

In the first and second embodiments, the tip position 5a is calculated by calculation using the command value of the feeding speed and the command value of the laser power. In a third embodiment, the additive manufacturing apparatus 100 calculates the tip position 5a by calculation using a feedback value of the feeding speed and a feedback value of the laser power. Consequently, regarding a calculation result of the tip position 5a, the additive manufacturing apparatus 100 can reduce errors caused by response delay of the hardware to the command. In the third embodiment, the same components as those in the first or second embodiment are denoted by the same reference numerals, and configurations different from those in the first or second embodiment will mainly be described.

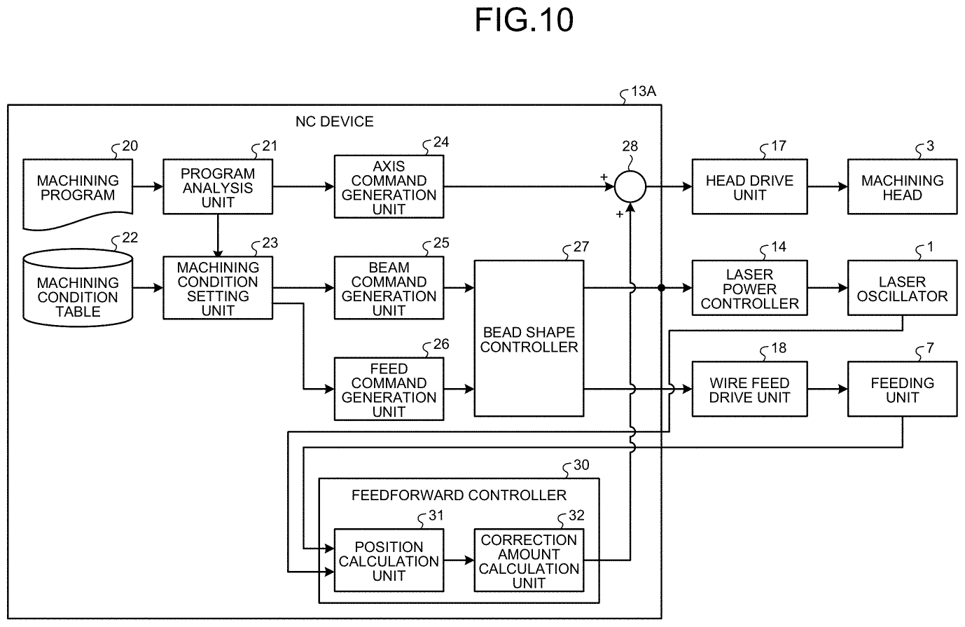

FIG. 10 is a diagram illustrating a functional configuration of a numerical control device that controls the additive manufacturing apparatus 100 according to the third embodiment. In an NC device 13A, a feedback value “F_{Wfb}” of the feeding speed is input from the feeding unit 7 to the position calculation unit 31 instead of the input of the command value of the feeding speed from the bead shape controller 27 to the position calculation unit 31. In the NC device 13A, a feedback value “P_{fb}” of the laser power is input from the laser oscillator 1 to the position calculation unit 31 instead of the input of the command value of the laser power from the bead shape controller 27 to the position calculation unit 31.

The position calculation unit 31 calculates the distance “L” by substituting the feedback value “F_{Wfb}” of the feeding speed and the feedback value “P_{fb}” of the laser power into the above-described formula (4). That is, the position calculation unit 31 calculates the tip position 5a by calculation using the feedback value “F_{Wfb}” of the feeding speed and the feedback value “P_{fb}” of the laser power.

According to the third embodiment, regarding the calculation result of the tip position 5a, the additive manufacturing apparatus 100 can reduce errors caused by response delay, by using the feedback value of the feeding speed and the feedback value of the laser power for the calculation in the position calculation unit 31.

### Fourth Embodiment

In the first to third embodiments, the tip position 5a is estimated on the basis of the period “tₘₑₗₜ” in which there is no change in the process parameters since the wire 5 entered the laser beam 4, that is, in a steady state. In a case where any of the process parameters is changed after the wire 5 entered the laser beam 4, the molten state of the wire 5 reaches a steady state corresponding to the changed process parameter, at timing delayed from timing when the any of the process parameters is changed. The transient response refers to a state from the timing when the process parameter is changed up to when the steady state is reached. The tip position 5a gradually changes due to the transient response from the timing when the process parameter is changed. As the amount of change in the process parameter increases, the influence of the transient response on the estimation result of the tip position 5a increases.

In the fourth embodiment, a description will be given for a method for calculating the tip position 5a that can reduce the influence of the transient response on the estimation result of the tip position 5a. In the fourth embodiment, the same components as those in the first to third embodiments described above are denoted by the same reference numerals, and a configuration different from those in the first to third embodiments will mainly be described.

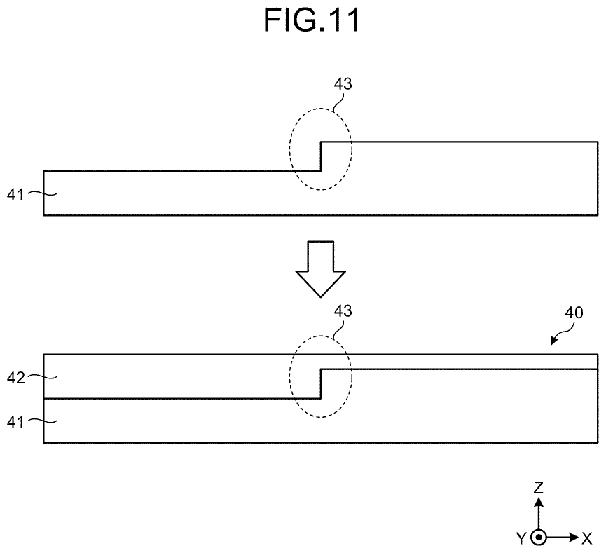

FIG. 11 is a view for explaining an example in which a process parameter is changed in the additive manufacturing apparatus 100 according to the fourth embodiment. FIG. 11 illustrates how a layer 42 of the bead 8 is stacked on a substrate 41. An upper surface of the substrate 41 which is a workpiece includes a step 43 at which the height in the Z-axis direction changes. In the example illustrated in FIG. 11, the additive manufacturing apparatus 100 changes the height of the layer 42 in the Z-axis direction in order to form a shaped object 40 in a flat shape by stacking the layer 42 on the substrate 41. The additive manufacturing apparatus 100 forms the layer 42 by moving the machining reference point RP in the positive direction in the X-axis direction.

The additive manufacturing apparatus 100 instantaneously decreases the feeding speed of the wire 5 when the machining reference point RP reaches the step 43. By the decrease in the feeding speed of the wire 5, the height of the layer 42 to be formed in a region on a positive side in the X-axis direction from the step 43 is made to be lower than that in a region on a negative side in the X-axis direction from the step 43. In this manner, the additive manufacturing apparatus 100 forms the shaped object 40 in a flat shape.

The additive manufacturing apparatus 100 reduces the feeding speed of the wire 5 by performing, in the bead shape controller 27, adjustment to reduce the command value of the feeding speed of the wire 5. During machining, the bead shape controller 27 dynamically adjusts the process parameter on the basis of a measurement result of the shape of the workpiece.

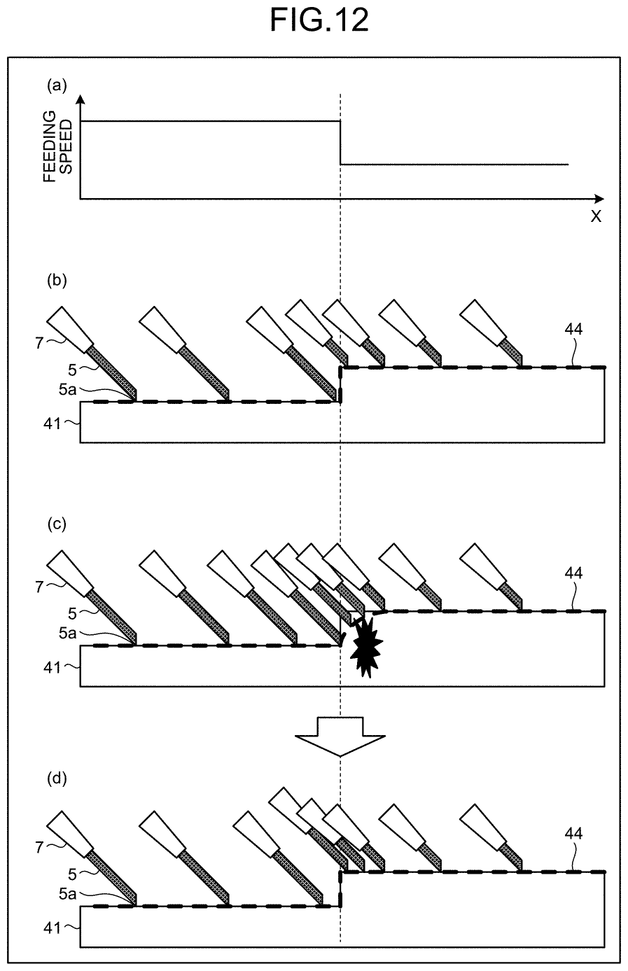

FIG. 12 is a view for explaining a method for calculating the tip position 5a in the additive manufacturing apparatus 100 according to the fourth embodiment. FIG. 12 schematically illustrates a relationship between the positions in the X-axis direction and the feeding speed of the wire 5 at the time of forming the layer 42, and the state of the wire 5 at each position in the X-axis direction. In FIG. 12, the layer 42 is not illustrated. (a) of FIG. 12 is a graph illustrating the relationship between the positions in the X-axis direction and the feeding speed of the wire 5. (b) of FIG. 12 illustrates an estimation result of the tip position 5a in a case where an adjustment for the transient response is not performed. (c) of FIG. 12 illustrates a state of the wire 5 in a case where the position of the machining reference point RP is corrected on the basis of the estimation result in the case where an adjustment for the transient response is not performed. (d) of FIG. 12 illustrates an estimation result of the tip position 5a and a state of the wire 5 in a case where an adjustment for the transient response is performed.

In the case where an adjustment for the transient response is not performed, the estimation result of the tip position 5a changes depending only on the process parameter. Therefore, it is estimated that when the feeding speed instantaneously decreases, the tip position 5a changes stepwise similarly to the change in the feeding speed. That is, as illustrated in (b) of FIG. 12, it is estimated that a travel path 44 of the tip position 5a instantaneously goes upward at the same time as the machining reference point RP reaches the step 43.

However, in an actual molten state, the tip position 5a gradually changes due to the transient response from the timing when the process parameter is changed. In a case where the position of the machining reference point RP is corrected on the basis of the estimation result illustrated in (b) of FIG. 12, the corrected travel path 44 illustrated in (c) of FIG. 12 gradually goes upward from when the machining reference point RP reaches the step 43. Therefore, the tip portion of the wire 5 collides with the substrate 41. That is, the stub phenomenon occurs. As described above, in machining in which the machining reference point RP moves from a lower side to a higher side of the step 43, the stub phenomenon may occur when an adjustment for the transient response is not performed. Note that, in machining in which the machining reference point RP moves from the higher side to the lower side of the step 43, the drop phenomenon may occur when the adjustment for transient response is not performed.

Therefore, in the fourth embodiment, the additive manufacturing apparatus 100 estimates the tip position 5a including the adjustment with respect to the transient response. By performing an adjustment for the transient response, the additive manufacturing apparatus 100 can correct the tip position 5a so as to instantaneously raise the tip position 5a at the same time as the machining reference point RP reaches the step 43 as illustrated in (d) of FIG. 12. Consequently, even when the process parameter is changed during machining, the additive manufacturing apparatus 100 can continue stable machining similarly to the case of the steady state.

Next, the estimation of the tip position 5a including the adjustment with respect to the transient response will be described. In order to estimate the tip position 5a including the adjustment with respect to the transient response, it is necessary to obtain accurate heat distribution in the wire 5. In the fourth embodiment, the additive manufacturing apparatus 100 divides the wire 5 into a plurality of minute-regions, and performs a simulation in which the amount of heat input when the wire 5 is moving inside the laser beam 4 is obtained by adding up for each of the minute-regions. The additive manufacturing apparatus 100 estimates a temperature for each minute-region on the basis of the input heat amount to calculate the tip position 5a. The additive manufacturing apparatus 100 can estimate the tip position 5a including the adjustment with respect to the transient response by estimating the temperature for each minute-region of the wire 5.

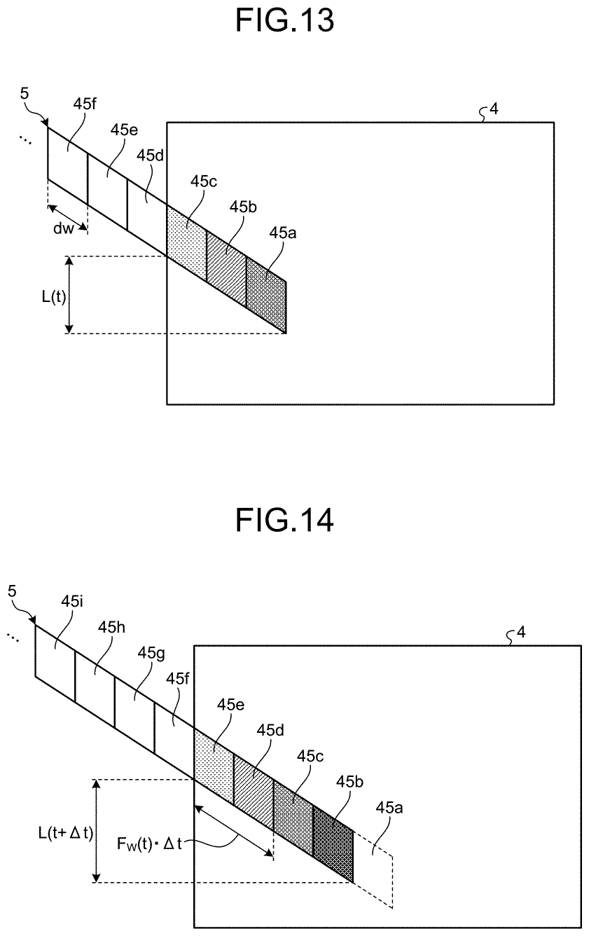

FIG. 13 is a first view for explaining estimation of the tip position 5a including the adjustment with respect to the transient response by the additive manufacturing apparatus 100 according to the fourth embodiment. In the simulation by the position calculation unit 31, the wire 5 is divided into a plurality of minute-regions positions of which are different from each other in the traveling direction of the wire 5 directed toward the workpiece from the feeding unit 7. Each of the six regions 45a, 45b, 45c, 45d, 45e, and 45f illustrated in FIG. 13 is a minute-region. The regions 45a, 45b, 45c, 45d, 45e, and 45f have the same width in the traveling direction of the wire 5, the width being “dw”.

The position calculation unit 31 obtains, for each of the minute-regions, a range of temperature rise due to irradiation with the laser beam 4 and the amount of movement accompanying the feeding of the wire 5 for every “At” which is a sampling time. Consequently, the position calculation unit 31 can know the temperature of each minute-region and the position of each minute-region. By knowing the temperature of each minute-region and the position of each minute-region, the position calculation unit 31 can estimate the tip position 5a in consideration of the molten state of the wire 5 during the transient response.

The simulation is performed on condition that the sampling time is set to “At”, and the wire 5 is divided into a plurality of minute-regions each of which has a width of “dw” in the traveling direction of the wire 5. In addition, it is assumed that, in the simulation, the influence of heat conduction in the wire 5 is neglected, and the temperature of part of the wire 5 present outside the laser beam 4 is constant.

Next, a procedure of the simulation will be described. FIG. 13 illustrates a state of the wire 5 at a time “t”. The region 45a is located at a tip on a workpiece side of the wire 5. In the wire 5, the minute-regions are arranged in the order of the regions 45a, 45b, 45c, 45d, 45e, and 45f from the tip on the workpiece side toward the feeding unit 7. The position calculation unit 31 stores a value of temperature of each minute-region.

In FIG. 13, three regions 45a, 45b, and 45c are inside the laser beam 4. Three regions 45d, 45e, and 45f are outside the laser beam 4. The temperatures “Tₖ(t)”, “Tₖ₊₁(t)”, “Tₖ₊₂(t)”, “Tₖ₊₃(t)”, “Tₖ₊₄(t)”, and “Tₖ₊₅(t)” of the regions 45a, 45b, 45c, 45d, 45e, and 45f satisfy the following: Tₖ(t)>Tₖ₊₁(t)>Tₖ₊₂(t)>Tₖ₊₃(t)=Tₖ₊₄(t)=Tₖ₊₅(t). “L(t)” is a distance in the Z-axis direction between the position of the wire 5 when the wire 5 enters the laser beam 4 and the tip of the wire 5 at the time “t”.

FIG. 14 is a second view for explaining the estimation of the tip position 5a including the adjustment with respect to the transient response by the additive manufacturing apparatus 100 according to the fourth embodiment. FIG. 14 illustrates a state of the wire 5 at a time “t+Δt”.

When the feeding speed at the time “t” is denoted by “F_{W}(t)”, the entirety of the wire 5 moves toward the workpiece by “F_{W}(t)·Δt” at the sampling time “Δt”. Here, with a feedback value of the feeding speed at the time “t” denoted by “F_{Wfb}(t)”, a moving distance of the wire 5 is “F_{Wfb}(t)·Δt”. The position calculation unit 31 specifies a minute-region inside the laser beam 4 on the basis of “F_{Wfb}(t)·Δt”. In FIG. 14, five regions 45a, 45b, 45c, 45d, and 45e are inside the laser beam 4. Four regions 45f, 45g, 45h and 45i are outside the laser beam 4. The position calculation unit 31 determines that the five regions 45a, 45b, 45c, 45d, and 45e are minute-regions inside the laser beam 4.

When a feedback value of the laser power at the time “t” is denoted by “P_{fb}(t)”, the regions 45a, 45b, 45c, 45d, and 45e inside the laser beam 4 receive heat of “P_{fb}(t)·Δt” at the sampling time “Δt”. The temperatures of the regions 45a, 45b, 45c, 45d, and 45e increase depending on the amount of heat input at the sampling time “Δt”.

In each minute-region inside the laser beam 4 at the time “t+Δt”, the amount of heat input of “P_{fb}(t)·Δt” is added to the amount of heat at the time “t”. The position calculation unit 31 can obtain a temperature “Tn(t+Δt)” of each minute-region inside the laser beam 4 at the time “t+Δt” using the following formula (8).

Tn(t+Δt)=Tn(t)+A·C_{P}·P_{fb}(t)·Δt (8)

In formula (8), Tn(t+Δt) represents the temperatures “Tₖ(t+Δt)”, “Tₖ₊₁(t+Δt)”, “Tₖ₊₂(t+Δt)”, “Tₖ₊₃(t+Δt)”, and “Tₖ₊₄(t+Δt)” of the respective regions 45a, 45b, 45c, 45d, and 45e at the time “t+Δt”. Tn(t) represents “Tₖ(t)”, “Tₖ₊₁(t)”, “Tₖ₊₂(t)”, “Tₖ₊₃(t)”, and “Tₖ₊₄(t)”. The position calculation unit 31 obtains the temperature “Tn(t+Δt)” of each minute-region to thereby update the temperature value stored for each of the regions 45a, 45b, 45c, 45d, and 45e.

The position calculation unit 31 compares the temperature “Tn(t+Δt)” after the update with the melting point of the wire 5, and removes a minute-region in which the temperature “Tn(t+Δt)” exceeds the melting point in the simulation. In a case where “Tₖ(t+Δt)” which is the temperature of the region 45a is higher than the melting point, the region 45a can be considered to have melted between the time “t” and the time “t+Δt”. In that case, the position calculation unit 31 removes the region 45a in the simulation.

The position calculation unit 31 specifies minute-regions “Tn(t+Δt)” of which is equal to or lower than the melting point from among minute-regions inside the laser beam 4. Furthermore, the position calculation unit 31 determines, as the tip position 5a, one minute-region closest to the workpiece in the traveling direction of the wire 5 among the specified minute-regions. In a case where “Tₖ+i(t+Δt)” which is the temperature of the region 45b is equal to or lower than the melting point, as a result of the removal of the region 45a, the region 45b falls under one minute-region “Tn(t+Δt)” of which is equal to or lower than the melting point and which is closest to the workpiece in the traveling direction of the wire 5. In that case, the position calculation unit 31 determines that the region 45b is the tip position 5a. As described above, the position calculation unit 31 calculates the tip position 5a by obtaining the amount of heat input in each of the plurality of minute-regions of the filler metal on the basis of the feeding speed and the beam power, and estimating the temperature for each minute-region on the basis of the input heat amount.

According to the fourth embodiment, the additive manufacturing apparatus 100 estimates the tip position 5a including the adjustment with respect to the transient response. The additive manufacturing apparatus 100 can reduce the influence of the transient response on the estimation result of the tip position 5a. Consequently, the additive manufacturing apparatus 100 can continue stable machining.

### Fifth Embodiment

In a case where the position of the machining reference point RP is corrected as in the first to fourth embodiments, the wire 5 before melting may touch the bead 8 depending on the moving direction of the machining reference point RP. In a fifth embodiment, adjustment of the correction amount “ΔZ” for separating the wire 5 before melting from the bead 8 will be described. With the adjustment of the correction amount “ΔZ”, the additive manufacturing apparatus 100 can reduce or prevent deterioration in the quality of the shaped object caused by the wire 5 before melting touching the bead 8. In the fifth embodiment, the same components as those in the first to fourth embodiments described above are denoted by the same reference numerals, and a configuration different from those in the first to fourth embodiments will mainly be described.

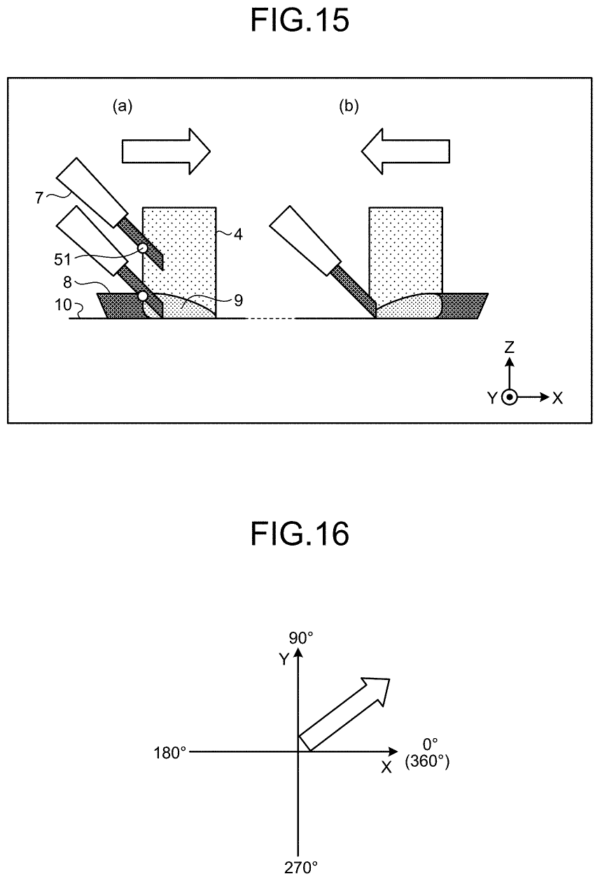

FIG. 15 is a view for explaining correction of a position of the machining reference point RP in the Z-axis direction and a moving direction of the machining reference point RP in the additive manufacturing apparatus 100 according to the fifth embodiment. The wire 5 to be fed from the feeding unit 7 to the workpiece is inclined in the negative direction in the X-axis direction with respect to the Z axis. In a case of (a) of FIG. 15, the moving direction of the machining reference point RP is the positive direction in the X-axis direction. In a case of (b) of FIG. 15, the moving direction of the machining reference point RP is the negative direction in the X-axis direction.

FIG. 16 is a diagram for explaining the definition of an angle representing the moving direction of the machining reference point RP in the additive manufacturing apparatus 100 according to the fifth embodiment. Each of angles of “0° (360°)”, “90°”, “180°”, and “270°” illustrated in FIG. 16 represents a direction in a two-dimensional plane of the X-axis direction and the Y-axis direction. In the fifth embodiment, the moving direction of the machining reference point RP in a plane perpendicular to the stacking direction is defined by any of angles from 0° to 360°. If the moving direction of the machining reference point RP is a direction of an outlined arrow illustrated in FIG. 16, the moving direction is 45°. The moving direction of the machining reference point RP in (a) of FIG. 15 is 0°. The moving direction of the machining reference point RP in (b) of FIG. 15 is 180°.

In the case of (a) of FIG. 15, when the machining head 3 is lowered so that the tip position 5a comes into contact with the molten bead 9, the wire 5 before melting may touch the bead 8. When the machining head 3 is lowered, in the wire 5, an intersection 51 between the wire 5 and an end of the laser beam 4 on a negative side in the X-axis direction first comes into contact with the bead 8. The phenomenon in which the wire 5 before melting touches the bead 8 may occur or may not occur depending on the height of the bead 8 in the Z-axis direction.

When the machining head 3 moves while the wire 5 before melting remain touching the bead 8, streaky traces may remain on the bead 8, and thereby the quality of the shaped object may be deteriorated. On the other hand, in the case of (b) of FIG. 15, when the machining head 3 is lowered so that the tip position 5a comes into contact with the molten bead 9, the wire 5 before melting does not touch the bead 8.

In a case where the moving direction of the machining reference point RP is included in the range of 0° to 90° or 270° to 360°, there is a possibility that the wire 5 before melting comes into contact with the bead 8 when the machining head 3 is lowered so that the tip position 5a comes into contact with the molten bead 9. Therefore, in the case where the moving direction of the machining reference point RP is included in the range of 0° to 90° or 270° to 360°, the phenomenon in which the wire 5 before melting touches the bead 8 may occur.

On the other hand, in a case where the moving direction of the machining reference point RP is included in the range of 90° to 270°, the wire 5 before melting does not come into contact with the bead 8 when the machining head 3 is lowered so that the tip position 5a comes into contact with the molten bead 9. Therefore, in the case where the moving direction of the machining reference point RP is included in the range of 90° to 270°, the phenomenon in which the wire 5 before melting touches the bead 8 does not occur.

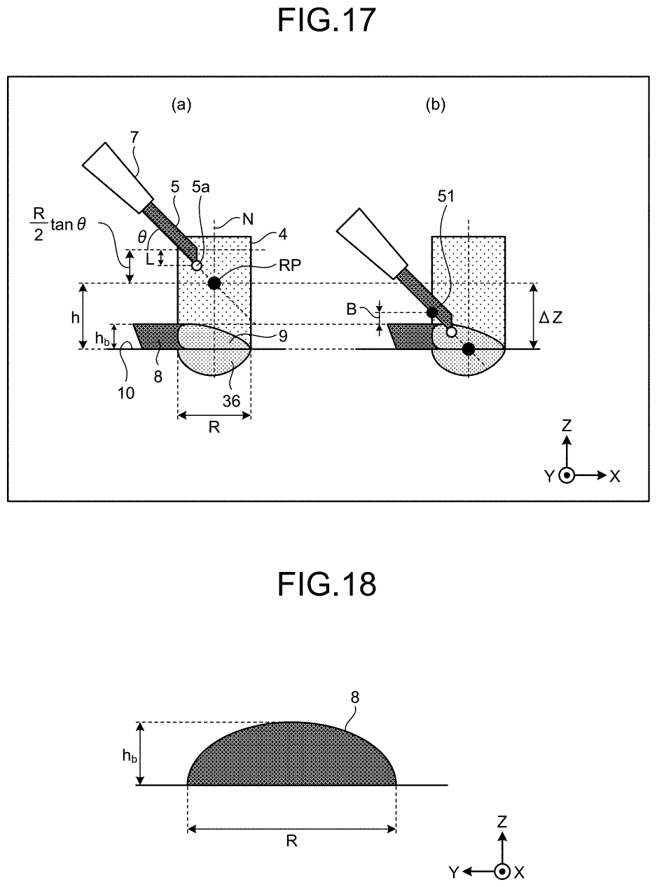

Next, adjustment of “ΔZ” which is a correction amount for correcting the position of the machining reference point RP will be described. FIG. 17 is a view for explaining adjustment of the correction amount for correcting the position of the machining reference point RP by the additive manufacturing apparatus 100 according to the fifth embodiment. (a) of FIG. 17 schematically illustrates a state of the tip position 5a and the workpiece before the position of the machining reference point RP is corrected. (b) of FIG. 17 schematically illustrates a state of the tip position 5a and the workpiece after the position of the machining reference point RP is corrected.

The correction amount calculation unit 32 adjusts “ΔZ” when the moving direction of the machining reference point RP is included in the range of 0° to 90° or the range of 270° to 360° and L<h_{b} holds. “h_{b}” represents the height in the Z-axis direction of the bead 8 formed on the workpiece. A method for estimating “h_{b}” will be described later.

The adjusted correction amount “ΔZ” for separating the wire 5 before melting from the bead 8 is expressed by the following formula (9).

ΔZ=−h−(R/2)tan θ+h_{b}+B (9)

“B” represents a distance between the bead 8 and the intersection 51 when the machining head 3 is lowered. “B” is set to about 100 μm to 200 μm. When “B” is set to zero, the wire 5 touches the bead 8. The correction amount calculation unit 32 calculates the adjusted “ΔZ” on the basis of formula (9). The correction amount calculation unit 32 outputs “ΔZ” which is the adjusted correction amount to the adder 28.

By controlling the machining head 3 on the basis of the axis command to which the adjusted “ΔZ” has been added, a gap having the distance “B” is provided between the bead 8 and the wire 5 before melting in a state where the machining head 3 is lowered so that the tip position 5a comes into contact with the molten bead 9. Consequently, the additive manufacturing apparatus 100 can prevent the phenomenon in which the wire 5 before melting touches the bead 8.

On the other hand, in the case where the moving direction of the machining reference point RP is included in the range of 90° to 270°, or a case where L≥h_{b} holds, the wire 5 before melting does not come into contact with the bead 8. In that case, the correction amount calculation unit 32 calculates “ΔZ” similarly to the cases of the first to fourth embodiments without performing the above-described adjustment.

As described above, the correction amount calculation unit 32 adjusts the correction amount “ΔZ” for correcting the position of the machining reference point RP on the basis of the moving direction of the machining reference point RP in the plane perpendicular to the stacking direction and the height of the bead 8 in the stacking direction. Consequently, the additive manufacturing apparatus 100 can prevent deterioration in the quality of the shaped object by preventing the phenomenon in which the wire 5 before melting touches the bead 8.

Next, a method for estimating “h_{b}” which is the height of the bead 8 will be described. FIG. 18 is a view for explaining the method for estimating the height of the bead 8 by the additive manufacturing apparatus 100 according to the fifth embodiment. Here, one of a plurality of methods considered to be methods for estimating the height of the bead 8 will be described. The additive manufacturing apparatus 100 may estimate the height of the bead 8 by a method other than the method described below.

The correction amount calculation unit 32 estimates the height of the bead 8 on the basis of the cross-sectional area of the bead 8, the cross-sectional shape of the bead 8, and the width of the bead 8. The cross-sectional area is the area of a YZ cross section of the bead 8. The correction amount calculation unit 32 performs the estimation on the basis of the volume of the bead 8 per unit length in the direction of the travel path 44. The correction amount calculation unit 32 may perform the estimation on the basis of the feeding speed of the wire 5 and the axial speed of the machining head 3. The cross-sectional area may be a result of dividing the feeding speed by the axial speed. The cross-sectional shape is the shape of the YZ cross section of the bead 8. The cross-sectional shape is assumed to be a portion including an arc of a circle. The width of the bead 8 is a width in a direction perpendicular to the stacking direction and the direction of the travel path 44. It is assumed that the width of the bead 8 is equal to “R” which is the diameter of the laser beam 4. The correction amount calculation unit 32 can calculate “h_{b}” by using a geometric relationship of circles.

According to the fifth embodiment, the additive manufacturing apparatus 100 adjusts the correction amount for correcting the position of the machining reference point RP on the basis of the moving direction of the machining reference point RP and the height of the bead 8 in the stacking direction, thereby being able to prevent the phenomenon in which the wire 5 before melting touches the bead 8. Consequently, the additive manufacturing apparatus 100 can prevent deterioration in the quality of the shaped object and can manufacture the shaped object with high quality.

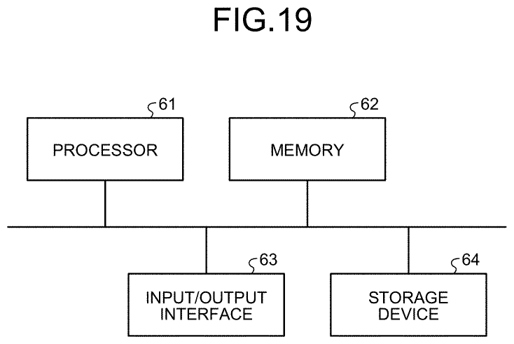

Next, a hardware configuration of the NC devices 13 and 13A included in the additive manufacturing apparatus 100 according to the first to fifth embodiments will be described. FIG. 19 is a diagram illustrating an example hardware configuration of each numerical control device included in the additive manufacturing apparatus 100 according to the first to fifth embodiments. FIG. 19 illustrates a hardware configuration in a case where the functions of each of the NC devices 13 and 13A are implemented by using hardware that executes a program.

The NC devices 13 and 13A each include a processor 61 that executes various processes, a memory 62 which is a built-in memory, an input/output interface 63 which is a circuit for inputting information to the NC device 13 or 13A and outputting information from the NC device 13 or 13A, and a storage device 64 that stores information.

The processor 61 is a central processing unit (CPU). The processor 61 may be a processing device, a microprocessor, a microcomputer, or a digital signal processor (DSP). The memory 62 is a random access memory (RAM), a read only memory (ROM), a flash memory, an erasable programmable read only memory (EPROM), or an electrically erasable programmable read only memory (EEPROM (registered trademark)).

The storage device 64 is a hard disk drive (HDD) or a solid state drive (SSD). A program for causing a computer to function as the NC device 13 or 13A is stored in the storage device 64. The processor 61 reads a program stored in the storage device 64 into the memory 62 and executes the program.

The program may be that stored in a storage medium readable by a computer system. Each of the NC devices 13 and 13A may store the program recorded in the storage medium in the memory 62. The storage medium may be a portable storage medium which is a flexible disk, or a flash memory which is a semiconductor memory. The program may be installed on the computer system from another computer or a server device via a communication network.

The functions of the program analysis unit 21, the machining condition setting unit 23, the axis command generation unit 24, the beam command generation unit 25, the feed command generation unit 26, the bead shape controller 27, the adder 28, and the feedforward controller 30 are implemented by a combination of the processor 61 and software. The functions may be implemented by a combination of the processor 61 and firmware, or may be implemented by a combination of the processor 61, the software, and the firmware. The software or the firmware is described as a program and stored in the storage device 64. In each of the NC devices 13 and 13A, the machining program 20, the machining condition table 22, and various types of data used in the above-described calculation are stored in the storage device 64.

The input/output interface 63 receives signals from various sensors connected to the hardware. In addition, the input/output interface 63 transmits a command to each of the laser power controller 14, the gas flow rate regulator 15, and the drive controller 16.

The configurations described in the respective embodiments above are merely examples of the content of the present disclosure. The configurations of the respective embodiments can be combined with other known technology. The configurations of the respective embodiments may be appropriately combined. Part of the configurations of the respective embodiments can be omitted or modified without departing from the gist of the present disclosure.

### REFERENCE SIGNS LIST

1 laser oscillator; 2 fiber cable; 3 machining head; 4 laser beam; 5 wire; 5a tip position; 6 wire spool; 7 feeding unit; 8 bead; 9 molten bead; 10, 41 substrate; 11, 12 rotary stage; 13, 13A NC device; 14 laser power controller; 15 gas flow rate regulator; 16 drive controller; 17 head drive unit; 18 wire feed drive unit; 19 stage drive unit; 20 machining program; 21 program analysis unit; 22 machining condition table; 23 machining condition setting unit; 24 axis command generation unit; 25 beam command generation unit; 26 feed command generation unit; 27 bead shape controller; 28 adder; 30 feedforward controller; 31 position calculation unit; 32 correction amount calculation unit; 35 position; 36 molten pool; 37 drop; 38 link; 40 shaped object; 42 layer; 43 step; 44 travel path; 45a, 45b, 45c, 45d, 45e, 45f, 45g, 45h, 45i region; 51 intersection; 61 processor; 62 memory; 63 input/output interface; 64 storage device; 100 additive manufacturing apparatus; N centerline; RP machining reference point.

1. An additive manufacturing apparatus that manufactures a shaped object by stacking a bead that is a solidified product of a filler metal caused to be melted, the additive manufacturing apparatus comprising:
a feeder to feed the filler metal to a workpiece;
a beam source to output a beam for melting the filler metal that is fed;
a processor; and
a memory to store a program which, when executed by the processor, performs processes of:
calculating a tip position of the filler metal, the tip position being a position where a temperature reaches a melting point of the filler metal by irradiation with the beam, on a basis of a feeding speed of the filler metal to be fed to the workpiece and beam power from the beam source.

2. The additive manufacturing apparatus according to claim 1, wherein the processor calculates the tip position on a basis of a physical property value of the filler metal, a parameter indicating a direction of the filler metal fed to the workpiece, the feeding speed, and the beam power.

3. The additive manufacturing apparatus according to claim 1, wherein the processor calculates the tip position by calculation using a command value of the feeding speed and a command value of the beam power.

4. The additive manufacturing apparatus according to claim 1, wherein the processor calculates the tip position by calculation using a feedback value of the feeding speed and a feedback value of the beam power.

5. The additive manufacturing apparatus according to claim 1, wherein the processor calculates the tip position by obtaining an input heat amount in each of a plurality of minute-regions of the filler metal, positions of the minute-regions being different from each other in a traveling direction of the filler metal directed toward the workpiece from the feeder, on a basis of the feeding speed and the beam power, and estimating a temperature of each of the minute-regions on a basis of the input heat amount.

6. The additive manufacturing apparatus according to claim 1, wherein
the processor further corrects a position of a machining reference point in a stacking direction in which the bead is stacked, the machining reference point being an intersection between a centerline of the beam directed toward the workpiece and a traveling direction of the filler metal directed toward the workpiece from the feeder, wherein
the processor corrects the position of the machining reference point on a basis of a calculation result of the tip position.

7. The additive manufacturing apparatus according to claim 6, wherein the processor adjusts a correction amount for correcting the position of the machining reference point, on a basis of a moving direction of the machining reference point in a plane perpendicular to the stacking direction and a height of the bead in the stacking direction.

8. An additive manufacturing method in which an additive manufacturing apparatus manufactures a shaped object by stacking a bead that is a solidified product of a filler metal caused to be melted, the additive manufacturing method comprising:
feeding the filler metal to a workpiece;
outputting a beam for melting the filler metal that is fed; and
calculating a tip position of the filler metal, the tip position being a position where a temperature reaches a melting point of the filler metal by irradiation with the beam, on a basis of a feeding speed of the filler metal in the feeding the filler metal and beam power in the beam outputting.

9. The additive manufacturing method according to claim 8, wherein
in the calculating, the tip position is calculated by calculation using values of the feeding speed and the beam power and a constant, and
the constant is calculated on a basis of a relationship between a minimum value of the feeding speed and the beam power when the filler metal fed toward the beam passes through the beam without being melted.

10. The additive manufacturing method according to claim 8, comprising:
correcting a position of a machining reference point in a stacking direction in which the bead is stacked, the machining reference point being an intersection between a centerline of the beam directed toward the workpiece and a traveling direction of the filler metal directed toward the workpiece in the feeding, wherein
in the correction, the position of the machining reference point is corrected on a basis of a calculation result of the tip position.
